(19) United States
(12) Patent Application Publication
(10) Pub. No.: US 2018/0309105 A1
(43) Pub. Date: Oct. 25, 2018

(54) MICROPOROUS MEMBRANE CONTAINING PORE-FORMING PARTICLES, A METHOD FOR PRODUCING SAME, AND AN ELECTROCHEMICAL CELL USING SAME

(71) Applicant: Samsung SDI Co., Ltd., Yongin-si, Gyeonggi-do (KR)

(72) Inventors: Hana RA, Suwon-si, Gyeonggi-do (KR); Younglim KOO, Suwon-si, Gyeonggi-do (KR); Suhak BAE, Suwon-si, Gyeonggi-do (KR); Sunghee AHN, Suwon-si, Gyeonggi-do (KR); Minjeong LEE, Suwon-si, Gyeonggi-do (KR)

(21) Appl. No.: 15/768,214

(22) PCT Filed: Aug. 2, 2016
(86) PCT No.: PCT/KR2016/008503

§ 371 Date: Apr. 13, 2018

(30) Foreign Application Priority Data
Oct. 15, 2015 (KR) 10-2015-0144274

(51) Int. Cl. H01M 2/16; H01M 10/0525

(52) U.S. Cl. CPC H01M 2/166; H01M 10/0525

(57) ABSTRACT

The present invention relates to a microporous membrane, a method for producing the same, and an electrochemical cell using the same, the microporous membrane comprising pore-forming particles and a thermoplastic resin having a melting point of 50° C. to 150° C., wherein the pore-forming particles have an average particle size of 300 nm or less, and are surface-treated with at least one selected from the group consisting of a phosphonic acid containing alkyl group having 10 or more carbon atoms, a carboxylic acid containing an alicyclic hydrocarbon group having 6 to 20 carbon atoms, resin acid, a benzenesulfonic acid containing alkyl group having 10 or more carbon atoms and a salt thereof.

### TECHNICAL FIELD

A microporous membrane including pore-forming particles, a method for producing the same, and an electrochemical cell using the same are disclosed.

### BACKGROUND ART

A separator for an electrochemical cell is an intermediate film that separates a positive electrode and a negative electrode in a battery, and maintains ion conductivity continuously to enable charge and discharge of a battery and consists of a microporous membrane.

A method of producing such a microporous membrane may be a dry process, a wet process, or a particle elongation process. The dry process is a method of forming a pore by preparing a precursor through extrusion, adjusting an alignment of lamellar through a heat treatment such as annealing and the like, and elongating it. The dry process does not use an extraction solvent unlike the wet process and thus is environmentally-friendly and has price competitiveness, but since a pore is formed through a uniaxial elongation, a microporous membrane may have a non-uniform thickness and decreased tensile strength in a length direction.

The wet process is a method of forming a pore by mixing a polymer material with a plasticizer, extruding the mixture to form a sheet, and removing the plasticizer from the sheet.

The particle elongation process may adjust a size of a pore around a particulate by mixing a polymer material with a particulate, extruding the mixture into a sheet, and elongating the sheet to form the pore along with destroying an interface of the polymer and the particulate but does not satisfy porosity and permeability required of a microporous membrane.

Accordingly, development of a microporous membrane having a uniform pore and excellent permeability is required.

### DISCLOSURE

### Technical Problem

An embodiment of the present invention is to provide a microporous membrane having excellent pore uniformity, permeability, and mechanical properties as well as excellent production efficiency along with a simple producing process and an electrochemical cell including the microporous membrane and thus having excellent characteristics such as stability, long-term reliability, and the like.

### Technical Solution

In an example embodiment, a microporous membrane includes a thermoplastic resin having a melting point of 100° C. to 200° C. and pore-forming particle, wherein the pore-forming particles have an average particle size of 300 nm or less, and are surface-treated with at least one selected from the group consisting of phosphonic acid containing alkyl group having 10 or more carbon atoms, a carboxylic acid containing an alicyclic hydrocarbon group having 6 to 20 carbon atoms, resin acid, benzene sulfonic acid containing alkyl group having 10 or more carbon atoms, and a salt thereof.

In another example embodiment, a microporous membrane includes surface-treated pore-forming particles having an average particle diameter of 300 nm or less, wherein the pore-forming particles are included in an amount of 20 wt % to 50 wt % based on a total weight of the microporous membrane and the microporous membrane has a puncture strength of greater than or equal to 200 gf.

In another example embodiment, a method of producing a microporous membrane includes preparing a composition for microporous membrane by mixing pore-forming particles surface-treated with a surfactant and a thermoplastic resin having a melting point of 100° C. to 200° C.; extrusion-molding the composition for microporous membrane to form a precursor film; annealing the precursor film at a temperature of (Tm-80) ° C. to (Tm-3) ° C.; and first elongating the annealed precursor film by 40% to 400% at a temperature of 0° C. to 50° C. in a machine direction (MD) or a transverse direction (TD) respectively or simultaneously, wherein Tm is a melting point of the thermoplastic resin.

In another example embodiment, an electrochemical cell includes the microporous membrane, a positive electrode, a negative electrode, and an electrolyte.

### Advantageous Effects

The microporous membrane according to example embodiments has improved dispersibility of pore-forming particles, includes pores formed uniformly and has improved permeability and mechanical properties, and a producing process is simple and production efficiency is good.

### DESCRIPTION OF THE DRAWING

FIG. 1 is an exploded perspective view of an electrochemical cell according to an embodiment.

### REFERENCE NUMERAL

100: electrochemical cell
10: positive electrode
20: negative electrode
30: separator
40: electrode assembly
50: case

### MODE FOR INVENTION

Hereinafter, the present invention is described in detail. The inventions that are not described in the present specification may be fully recognized and by conveyed by those skilled in the art in a technical or similar field of the present invention and thus are omitted herein.

In an example embodiment, a microporous membrane includes a thermoplastic resin having a melting point (Tm) of 100° C. to 200° C. and pore-forming particles. The pore-forming particle may have an average particle diameter of 300 nm or less and may be included in an amount of 20 wt % to 50 wt % as a surface-treated particle in the microporous membrane. The microporous membrane has improved permeability and mechanical properties and may function as a separator having improved stability and long-term reliability in an electrochemical cell by dispersing nano-sized particles uniformly and forming uniform pores in the porous membrane.

When the thermoplastic resin having a melting point of 100° C. to 200° C. is used, it may perform shut-down function at a temperature above a melting point. Examples of the thermoplastic resin may be a polyolefin-based resin and the polyolefin-based resin has a good shut-down function to contribute safety improvement of a battery. Examples of the polyolefin-based resin may be polyethylene, polypropylene, or a mixture thereof. Examples of polyethylene may be high density polyethylene and the high density polyethylene resin has a high lamellar complement degree of a crystal part of the resin and a thick thickness due to improved structural regularity of the polymer itself. The high density polyethylene may have a melt index of 0.03 to 5, specifically 0.1 to 2, and more specifically 0.1 to 1. In an embodiment, at least two high density polyethylenes having a different melt index may be mixed and specifically may use high density polyethylene having a melt index of 0.03 to 0.3 and high density polyethylene having a melt index of 0.5 to 1.

The thermoplastic resin having a melting point (Tm) of 100° C. to 200° C. may have a weight average molecular weight (Mw) of 100,000 to 500,000. Within the range of the molecular weight, dispersibility of pore-forming particles may be improved, desirable viscosity during extrusion may be provided, and a strength of the microporous membrane may be good. More specifically, a thermoplastic resin having a weight average molecular weight of 150,000 to 400,000 may be used and even more specifically a thermoplastic resin having a weight average molecular weight of 150,000 to 300,000 may be used. At last two thermoplastic resins having a different weight average molecular weight may be mixed. The weight average molecular weight may be polystyrene-reduced average molecular weight measured by gel permeation chromatography.

The thermoplastic resin may be included in an amount of 50 wt % to 80 wt % based on the total weight of the microporous membrane. Within the ranges, thickness uniformity, sufficient porosity, and ion permeability of the microporous membranes may be obtained.

For another example, the microporous membrane may include other different resin in addition to the thermoplastic resin having a melting point of 100° C. to 200° C. Examples of the other different resin may have a melting point of less than 100° C. and greater than 200° C. and may be polypropylene, poly (4-methylpentene), polyethyleneterephthalate, polyimide, polyester, polyamide, polyetherimide, polyamideimide, polyacetal, polyketone, or a combination thereof. When the microporous membrane includes the other different resin, the thermoplastic resin and the other different resin may be blend in a desirable solvent. For another example, the microporous membrane may further include a copolymer of olefin and a non-olefin monomer.

The microporous membrane includes surface-treated pore-forming particles in addition to the thermoplastic resin. The surface-treatment may be surface-treatment with a surfactant.

Specifically, the pore-forming particles may be surface-treated with at least one material selected from the group consisting of phosphonic acid containing an alkyl group having 10 or more and specifically 10 to 20 carbon atoms, a carboxylic acid containing an alicyclic hydrocarbon group having 6 to 20 carbon atoms, resin acid, benzene sulfonic acid containing alkyl group having 10 or more and specifically 10 to 20 carbon atoms, and a salt thereof. More specifically, the pore-forming particles may be surface-treated with phosphonic acid containing an alkyl group having 10 to 20 carbon atoms, resin acid, benzene sulfonic acid containing an alkyl group having 10 to 20 carbon atoms, or a sulfonate salt.

When the pore-forming particles surface-treated with the materials is mixed with the thermoplastic resin, dispersibility may be improved while not deteriorating insulation properties or heat resistance of the thermoplastic resin. Specifically, the pore-forming particles surface-treated with the materials improves dispersibility of pore-forming particles and thereby small sized particles may be uniformly dispersed in the thermoplastic resin without agglomeration and fine sized pores may be formed.

The phosphonic acid containing alkyl group having 10 or more carbon atoms may be n-decylphosphonic acid, o-decylphosphonic acid, n-dodecylphosphonic acid, o-dodecylphosphonic acid, n-hexadecylphosphonic acid, o-hexadecylphosphonic acid, n-octadecylphosphonic acid, o-octadecylphosphonic acid, and the like and the carboxylic acid containing an alicyclic hydrocarbon group having 6 to 20 carbon atoms may be cyclopentane carboxylic acid, cyclohexane carboxylic acid, cycloheptane carboxylic acid, naphthenic acid, and the like. The resin acid may specifically include three condensed rings and may be carboxylic acid represented by C₁₉H₂₉COOH, and more specifically abidetic acid, neoabidetic acid, hydroabidetic acid, pimaric acid, levopimaric acid, isopimaric acid, palustric acid, dextonic acid, porocarpic acid, agathenedicarboxylic acid, benzoic acid, cinnamic acid, p-hydroxycinnamic acid, and the like. Examples of the benzene sulfonic acid containing alkyl group having 10 or more carbon atoms or sulfonate salt may be decyl benzene sulfonic acid, undecyl benzene sulfonic acid, dodecyl benzene sulfonic acid, a sodium dodecyl benzene sulfonate salt, and the like. The materials may be included in an amount of 10 wt % or less, and specifically 1 wt % to 5 wt % based on the total weight of the pore-forming particles.

The pore-forming particle may be inorganic particles or organic particles.

Specifically the pore-forming particles may be inorganic particles and examples of the inorganic particle may be alumina, silica, Mania, zirconia, magnesia, ceria, zinc oxide, iron oxide, silicon nitride, titanium nitride, boron nitride, calcium carbonate, aluminum sulfate, barium sulfate, aluminum hydroxide, barium titanate, calcium titanate, talc, calcium silicate, magnesium silicate, and the like. For example, one selected from the group consisting of alumina, calcium carbonate, barium sulfate, and aluminum hydroxide, a mixture thereof may be used.

The pore-forming particles may have an average particle diameter of less than or equal to about 300 nm, and specifically, 30 nm to 300 nm. More specifically, it may be 30 nm to 250 nm and even more specifically 30 nm to 200 nm, for example, 30 nm to 100 nm, or 50 nm to 100 nm. Accordingly, a particulate having a size within the range may have an advantage in terms of a pore size adjustment, pore uniformity, and permeability. In addition, the particulate having a size within the range is advantageous in terms of pore uniformity and permeability without deteriorating dispersibility of pore-forming particles and processibility and may prevent deterioration of mechanical properties of the microporous membrane. Herein, the average particle diameter may denote a particle size at a volume ratio of 50% in a cumulative size-distribution curve.

In addition, the pore-forming particles may be included in an amount of 20 wt % to 50 wt %, and specifically 30 wt % to 50 wt % based on a total weight of the microporous membrane. Within the ranges, sufficient pores are formed by pore-forming particles and thus permeability may be improved.

A method of surface-treating the pore-forming particles is not particularly limited, and an ordinary method in the art may be used. The surface treatment may be, for example, performed in a dry method of directly mixing the pore-forming particles with a surface treatment material with a Henschel mixer, heat-treating the mixture if necessary, and the like. In addition, the surface treatment material may be diluted in an appropriate solvent.

The microporous membrane may have a thickness of 1 μm to 20 μm, and specifically 5 μm to 20 μm. A porous film having a thickness within the range may be a microporous membrane having an appropriate thickness, which is sufficiently thick enough to prevent a short circuit of positive and negative electrodes of a battery but not as thick as to increase internal resistance of the battery.

In an example embodiment, porosity of the microporous membrane may be 40% or greater, specifically 40% to 70%, more specifically 40% to 60%, or 40% to 55%. The microporous membrane having porosity within the ranges, pores are sufficiently formed and thus permeability, ion permeability, and the like are improved. Non-limiting example of a method of measuring the porosity is as follows. The microporous membrane is cut into width 50 mm×length 50 mm to obtain three specimens, volumes, masses, and density thereof are measured, the average is obtained, and the average values are put in Equation 1 to obtain porosity (%).

Porosity (%)={volume(cm³)−mass(g)/density(g/cm³)}/volume(cm³)×100 [Equation 1]

The microporous membrane may have permeability of less than or equal to 300 sec/100 cc, specifically, less than or equal to 200 sec/100 cc, and more specifically, less than or equal to 180 sec/100 cc. When the microporous membrane has permeability within the range, ions may easily move between the positive and negative electrodes. A method of measuring permeability of the microporous membrane is not particularly limited but includes non-limiting examples as follows. The permeability may be measured by cutting the microporous membrane at left, middle, and right to prepare three specimens having a size of each width and length of 50 mm, three times measuring how long it takes 100 cc of air to pass each specimen with a permeability measuring device (EG01-55-1MR, Asahi Seiko Inc.), and averaging the measurements

In addition, the microporous membrane may have puncture strength of greater than or equal to 200 gf and specifically, greater than or equal to 250 gf. The puncture strength is one measurement showing a hardness degree of a microporous membrane and may be measured in a generally-used method in a related art. Non-limiting examples of the method of measuring the puncture strength are as follows: the microporous membrane are cut into a size of a width 50 mm×a length 50 mm at ten different points to prepare ten specimens, each specimen is put on a 10 cm hole by using a GATO Tech G5 equipment, and puncture strength of each specimen is three times measured while pushed down with a 1 mm probe needle and averaged.

In addition, the microporous membrane may have average tensile strength of greater than or equal to 1000 Kgf/cm² and specifically, greater than or equal to 1200 Kgf/cm² in a machine direction (MD). Within the range, the microporous membrane may be less breakable during the elongation. A method of measuring the tensile strength is not particularly limited but includes non-limiting examples as follows. Average tensile strength of the microporous membrane in a machine direction (MD) is measured by cutting the microporous membrane to prepare ten specimens having a rectangular shape of a width 10 mm×a length 50 mm at all different ten places, respectively mounting and clipping the ten specimens on a universal testing machine (UTM), and elongating them until it has a length of 20 mm.

Another example embodiment relate to a microporous membrane including surface-treated pore-forming particles having an average particle diameter of 300 nm or less, wherein the pore-forming particles are included in an amount of 20 wt % to 50 wt % based on a total weight of the microporous membrane and the microporous membrane may have a puncture strength of 200 gf or greater.

The microporous membrane may have puncture strength of greater than or equal to 200 gf and specifically, greater than or equal to 250 gf. The puncture strength is the same as illustrated in the aforementioned embodiment. A microporous membrane having puncture strength within the range may show appropriate strength for a separator and excellent reliability.

The pore-forming particles also may be the same as illustrated in the aforementioned embodiment and specifically, inorganic particles or organic particles and more specifically, the inorganic particles.

For one example, the pore-forming particles may be surface-treated with phosphonic acid containing alkyl group having 10 or more carbon atoms, a carboxylic acid containing an alicyclic hydrocarbon group having 6 to 20 carbon atoms, resin acid, benzene sulfonic acid containing alkyl group having 10 or more carbon atoms, or a salt thereof. These are the same as described in the foregoing embodiments.

Hereinafter, a method of producing the microporous membrane according to an example embodiment is described.

A method of producing the microporous membrane includes preparing a composition for microporous membrane by mixing pore-forming particles surface-treated with a surfactant and a thermoplastic resin having a melting point of 100° C. to 200° C.; extrusion-molding the composition for microporous membrane to form a precursor film; annealing the precursor film at a temperature of (Tm-80) ° C. to (Tm-3) ° C.; first elongating the annealed precursor film by 40% to 400% at a temperature of 0° C. to 50° C. in a machine direction (MD) or a transverse direction (TD) respectively or simultaneously.

The pore-forming particles surface-treated with a surfactant and the thermoplastic resin having a melting point of 100° C. to 200° C. are the same as aforementioned, and hereinafter, a method of forming a microporous membrane by using them is mainly illustrated.

First, pore-forming particles are surface-treated with a surfactant. Examples of the surfactant may include phosphonic acid containing an alkyl group having 10 or more carbon atoms, a carboxylic acid containing an alicyclic hydrocarbon group having 6 to 20 carbon atoms, resin acid, benzene sulfonic acid containing an alkyl group having 10 or more carbon atoms, or a salt thereof. A method of performing the surface treatment is the same as illustrated in the aforementioned embodiment.

Next, the surface-treated pore-forming particles is mixed with a thermoplastic resin having a melting point of 100° C. to 200° C. to prepare a composition for a microporous membrane. The mixing may be not particularly limited but may be performed by melting the thermoplastic resin and the pore-forming particles surface-treated with a surfactant at 80° C. to 250° C. in a dispersion kneader and then, kneading them for 10 minutes to 30 minutes to obtain the composition for a microporous membrane.

Subsequently, the composition for microporous membrane is extruded and molded to form a precursor film. A method of forming the precursor film is not particularly limited thereto but may be a generally used method. For example, the composition for microporous membrane is processed at 100° C. to 200° C. for 1 minute to 60 minutes into a pellet, and the pellet is melt at 150° C. to 300° C. with a single screw or twin screw extruder and formed into a precursor film in a T-die method, an inflation method, and the like. In an embodiment, the pellet may be formed into a precursor film through a blown film line. The precursor film may have a thickness of 1 μm to 500 μm, for example, 5 μm to 300 μm, and specifically, 10 μm to 200 μm.

The produced precursor film may be annealed at a temperature of (Tm-80) ° C. to (Tm-3) ° C. The annealing is a heat treatment process of improving a crystal structure and an alignment structure to promote formation of a micropore during the elongation, and accordingly, a pore formation, a pore size adjustment, and the like may be easily accomplished. For example, the annealing may be performed in a method of treating the precursor film by putting a substrate roll in a thermal convection oven, contacting the precursor film with a heated roll or a heated metal plate, applying heat to the precursor film through hot air in a tenter, an infrared ray heater, or the like. The annealing may be performed at 100° C. to 150° C. and specifically, 120° C. to 140° C. for 10 minutes to 60 minutes, specifically, 20 minutes to 50 minutes, and for example, 30 minutes. The thermoplastic resin may have Tm in a range of 100° C. to 200° C. Specifically, when the thermoplastic resin is a polyethylene-based resin, Tm may be in a range of 120° C. to 150° C., and polypropylene may have Tm ranging from 160° C. to 190° C.

Subsequently, the annealed precursor film may be first elongated by 40% to 400% in a machine direction, a transverse direction, or simultaneously, both directions at 0° C. to 50° C. The elongation process is a pore-forming process and may be, for example, performed in one direction (a MD direction) through a roll-type or tenter-type elongation. The temperature may be in a range of 5° C. to 40° C. and specifically, 10° C. to 35° C.

In addition, an elongation rate may be in a range of 40% to 400%, specifically, 80% to 200%, and more specifically, 80% to 100%, and the elongation may be, for example, once performed in a machine direction (MD). When the elongation rate is within the range, an amorphous region is sufficiently cracked during the elongation process and may accomplish desired permeability or porosity. The elongated film has low crystallinity and thus may be elongated in a thin lamellar layer distance during the following elongation process and also not broken despite a high speed elongation, and accordingly, a process speed may be improved.

A method of producing a microporous membrane according to another example embodiment may additionally include second elongation of the first elongated film by 5% to 400% at a temperature of (Tm-70) ° C. to (Tm-3) ° C. in a machine or transverse direction respectively or simultaneously in both directions.

The second elongation may include 5% to 400% elongation of the first elongated film at (Tm-70) ° C. to (Tm-3) ° C. in a machine or transverse direction respectively or simultaneously in both directions. The second elongation is 5% to 400%, for example, 50% to 200% performed by using a roll-type or tenter-type device at (Tm-70) ° C. to (Tm-3) ° C. in a machine or transverse direction respectively or simultaneously in both directions. The second elongation may be performed specifically at 100° C. to 150° C., for example, at 120° C. to 150° C.

In an example embodiment, when at least two kinds of thermoplastic resins are mixed, Tm in the process may be an average of each Tm of the at least two kinds of thermoplastic resins.

After the first or second elongation, heat-fixing may be additionally performed, if necessary. The heat-fixing is a process of 110% to 150% and specifically 110% to 130% elongating the film in a machine or transverse direction respectively or simultaneously both directions at (Tm-70) ° C. to (Tm-3) ° C. by using a roll-type or tenter-type device and then, relaxing the film up to 80% to 100% and specifically 80% to 90% of the elongated length or width and thus reducing a residual stress and a contraction rate. When the film is not through the heat-fixing, crystals tend to be restored to an original state. In addition, when the film is heat-fixed, a thermal contraction rate of the microporous membrane may be improved.

A method of producing the microporous membrane according to the example embodiments may use an antioxidant, an antistatic agent, a neutralizing agent, a dispersing agent, an anti-blocking agent, a slip agent, and the like, as needed.

According to an example embodiment, a separator including the microporous membrane is provided. The separator may consist of the microporous membrane or may further include a porous adhesive layer formed on one surface or both surfaces of the microporous membrane. The porous adhesive layer may include a binder resin and inorganic particles as needed.

In an example embodiment, an electrochemical cell includes a separator including the microporous membrane, a positive electrode, and a negative electrode which are filled with an electrolyte.

The kind of the electrochemical cell is not particularly limited, and it may be the known kind of cell in the art. Specifically, the electrochemical cell of the present invention may be a lithium rechargeable cell such as a lithium metal rechargeable cell, a lithium ion rechargeable cell, a lithium polymer rechargeable cell, or a lithium ion polymer rechargeable cell.

A method of producing the electrochemical cell is not particularly limited, but may include the commonly used method in the art.

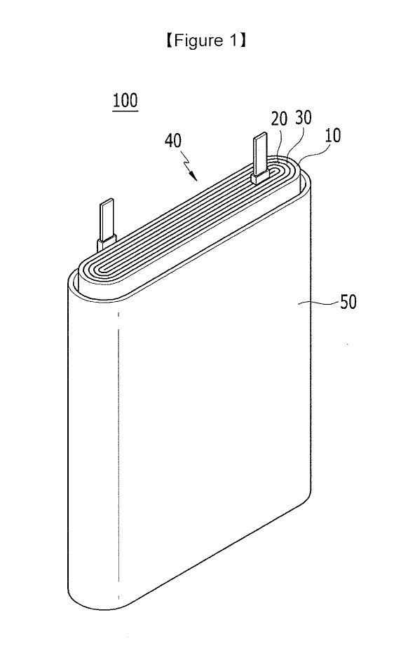

FIG. 1 is an exploded perspective view of an electrochemical cell according to an embodiment. An electrochemical cell according to an embodiment is illustrated as a prismatic cell but is not limited thereto and may include variously-shaped batteries such as a lithium polymer cell, a cylindrical cell, and the like.

Referring to FIG. 1, an electrochemical cell 100 according to an embodiment includes an electrode assembly 40 manufactured by winding a separator 30 interposed between a positive electrode 10 and a negative electrode 20, and a case 50 housing the electrode assembly 40. An electrolyte (not shown) may be impregnated in the positive electrode 10, the negative electrode 20, and the separator 30.

The separator 30 is the same as described above.

The positive electrode 10 may include a positive current collector and a positive active material layer formed on the positive current collector. The positive active material layer may include a positive active material, a binder, and optionally a conductive material.

The positive current collector may use aluminum (Al), nickel (Ni), and the like, but is not limited thereto.

The positive active material may use a compound being capable of intercalating and deintercalating lithium. Specifically, as the positive active material, at least one of a composite oxide or a composite phosphate of a metal selected from cobalt, manganese, nickel, aluminum, iron, or a combination thereof and lithium may be used. For example, the positive active material may be a lithium cobalt oxide, a lithium nickel oxide, a lithium manganese oxide, a lithium nickel cobalt manganese oxide, a lithium nickel cobalt aluminum oxide, a lithium iron phosphate, or a combination thereof.

The binder improves binding properties of positive active material particles with one another and with a current collector, and specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. These may be used alone or as a mixture of two or more.

The conductive material improves conductivity of an electrode and examples thereof may be natural graphite, artificial graphite, carbon black, a carbon fiber, a metal powder, a metal fiber, and the like, but are not limited thereto. These may be used alone or as a mixture of two or more. The metal powder and the metal fiber may use a metal of copper, nickel, aluminum, silver, and the like.

The negative electrode 20 includes a negative current collector and a negative active material layer formed on the negative current collector.

The negative current collector may use copper (Cu), gold (Au), nickel (Ni), a copper alloy and the like, but is not limited thereto.

The negative active material layer may include a negative active material, a binder, and optionally a conductive material.

The negative active material may be a material that reversibly intercalates/deintercalates lithium ions, a lithium metal, a lithium metal alloy, a material being capable of doping and dedoping lithium, a transition metal oxide, or a combination thereof.

The material that reversibly intercalates/deintercalates lithium ions may be a carbon material which is any generally-used carbon-based negative active material, and examples thereof may be crystalline carbon, amorphous carbon, or a combination thereof. Examples of the crystalline carbon may be may be graphite such as amorphous, sheet-shape, flake, spherical shape, or fiber-shaped natural graphite or artificial graphite. Examples of the amorphous carbon may be soft carbon or hard carbon, a mesophase pitch carbonized product, fired coke, and the like. The lithium metal alloy may be an alloy of lithium and a metal selected from the group consisting of Na, K, Rb, Cs, Fr, Be, Mg, Ca, Sr, Si, Sb, Pb, In, Zn, Ba, Ra, Ge, Al, and Sn. The material being capable of doping and dedoping lithium may be Si, SiOₓ (0<x<2), a Si—C composite, a Si—Y alloy, Sn, SnO₂, a Sn—C composite, a Sn—Y alloy, and the like, and at least one of these may be mixed with SiO₂. Specific examples of the element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. The transition metal oxide may be vanadium oxide, lithium vanadium oxide, and the like.

The binder and the conductive material used in the negative electrode 20 may be the same as the binder and conductive material of the positive electrode.

The positive electrode 10 and the negative electrode 20 may be manufactured by mixing each active material composition including each active material and a binder, and optionally a conductive material in a solvent, and coating the active material composition on each current collector. Herein, the solvent may be N-methylpyrrolidone, and the like, but is not limited thereto. The electrode producing method is well known, and thus is not described in detail in the present specification.

The electrolyte includes an organic solvent a lithium salt.

The organic solvent serves as a medium for transmitting ions taking part in the electrochemical reaction of a cell. Specific examples thereof may be selected from a carbonate-based solvent, an ester-based solvent, an ether-based solvent, a ketone-based solvent, an alcohol-based solvent, and an aprotic solvent.

Examples of the carbonate based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. Specifically, when a linear carbonate compound and a cyclic carbonate compound are mixed, a solvent having a high dielectric constant and a low viscosity may be provided. Herein, the cyclic carbonate compound and the linear carbonate compound may be mixed together in a volume ratio ranging from 1:1 to 1:9.

Examples of the ester-based solvent may be methylacetate, ethylacetate, n-propylacetate, dimethylacetate, methylpropionate, ethylpropionate, γ-butyrolactone, decanolide, valerolactone, mevalonolactone, caprolactone, and the like. Examples of the ether-based solvent may be dibutylether, tetraglyme, diglyme, dimethoxyethane, 2-methyltetrahydrofuran, tetrahydrofuran, and the like. Examples of the ketone-based solvent may be cyclohexanone, and the like and the alcohol-based solvent may be ethanol, isopropyl alcohol, and the like.

The organic solvent may be used alone or in a mixture, and when the organic solvent is used in a mixture, the mixture ratio may be controlled in accordance with a desirable cell performance.

The lithium salt is dissolved in an organic solvent, supplies lithium ions in a cell, basically operates a rechargeable battery, and improves lithium ion transportation between positive and negative electrodes therein.

Examples of the lithium salt may be LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) wherein, x and y are natural numbers, LiCl, LiI, LiB(C₂O₄)₂, or a combination thereof.

The lithium salt may be used in a concentration ranging from 0.1 M to 2.0 M. When the lithium salt is included within the above concentration range, an electrolyte may have excellent performance and lithium ion mobility due to optimal electrolyte conductivity and viscosity.

The electrochemical cell 100 according to an embodiment may have a cycle charge and discharge maintenance rate of 70% to 100% and specifically, 80% to 100%.

Hereinafter, preferable Examples are illustrated to explain structures and functions the present invention in more detail. However, Examples are examples of the present invention and the present invention is not limited thereto. Furthermore, what is not described in this invention may be sufficiently understood by a person having a skilled art in this field and will not be illustrated here.

### EXAMPLES AND COMPARATIVE EXAMPLES

### Preparation Example 1: Preparation of Composition for Microporous Membrane

<Preparation of Surface-Treated Pore-Forming Particle 1>

485 g of calcium carbonate having an average particle diameter (D50) of 60 nm (Okyumhwa RA, DongHo Calcium Corp.) was mixed with 15 g of a sodium dodecyl benzene sulfonate salt with a Henschel mixer, and the mixture was heat-treated at 60° C. to 80° C. to prepare pore-forming particles surface-treated with the sodium dodecyl benzene sulfonate salt.

<Production of Surface-Treated Pore-Forming Particles 2>

Barium sulfate having an average particle diameter (D50) of 60 nm (BARIFINE_10, Sakai Chemical Industry Co., Ltd.) was surface-treated with a sodium dodecyl benzene sulfonate salt according to the same method as done for the aforementioned calcium carbonate.

<Preparation of Composition for Microporous Membrane>

27.5 wt % of linear high density polyethylene having a melt flow rate (MFR) of 0.3, a weight average molecular weight of 200,000, and a melting point of 137° C. (hereinafter, referred to be ‘HDPE 1,’ HIVOREX 5200, Lotte Chemical Corp.), 27.5 wt % of linear high density polyethylene having a melt flow rate (MFR) of 0.95, a weight average molecular weight of 150,000, and a melting point of 137° C. (hereinafter, referred to be ‘HDPE 2,’ HIVOREX 5000S, Lotte Chemical Corp.), and 45 wt % of the surface-treated pore-forming particle 1 were completely melted in a dispersion kneader at 150° C. and additionally kneaded for 10 to 20 minutes to prepare a composition for a microporous membrane.

### Preparation Example 2: Preparation of Composition for Microporous Membrane

A composition for a microporous membrane according to Preparation Example 2 was prepared according to the same method as Preparation Example 1 except for using rosin (Sigma-Aldrich Corp.) instead of the sodium dodecyl benzene sulfonate salt for the surface treatment.

### Preparation Example 3: Preparation of Composition for Microporous Membrane

A composition for a microporous membrane according to Preparation Example 3 was prepared according to the same method as Preparation Example 1 except for using decylphosphonic acid (Sigma-Aldrich Corp.) instead of the sodium dodecyl benzene sulfonate salt for the surface treatment.

### Preparation Example 4: Preparation of Composition for Microporous Membrane

A composition for microporous membrane according to Preparation Example 4 was prepared according to the same method as Preparation Example 1 except for using naphthenic acid (TCI International Inc.) instead of the sodium dodecyl benzene sulfonate salt for the surface treatment.

### Preparation Example 5: Preparation of Composition for Microporous Membrane

A composition for microporous membrane according to Preparation Example 5 was prepared according to the same method as Preparation Example 1 except for using 22.5 wt % of the surface-treated pore-forming particles 1 and 22.5 wt % of the surface-treated pore-forming particles 2 instead of 45 wt % of the surface-treated pore-forming particles 1.

### Comparative Preparation Example 1: Preparation of Composition for Microporous Membrane

A composition for a microporous membrane according to Comparative Preparation Example 1 was prepared according to the same method as Preparation Example 1 except for using calcium carbonate without a surface treatment.

### Comparative Preparation Example 2: Preparation of Composition for Microporous Membrane

A composition for microporous membrane according to Comparative Preparation Example 2 was prepared according to the same method as Preparation Example 2 except for using calcium carbonate having an average particle diameter (D50) of 1.5 μm (Okyumhwa TL-1000, DongHo Calcium Corp.).

### Examples 1 to 5 and Comparative Examples 1 to 2: Production of Microporous Membrane

The compositions for microporous membrane according to Preparation Example 1 to 5 and Comparative Preparation Example 1 to 2 were respectively processed at 150° C. for 15 minutes with a dispersion mixer and prepared into each pellet, and the pellet was melt at 210° C. in an extruder and formed into a microporous membrane precursor film through a blown film line. The microporous membrane precursor film was annealed at 120° C. in a hot air oven for 30 minutes. Subsequently, the annealed precursor film was 100% elongated along a machine direction (MD) at 25° C. and 200% elongated along the machine direction at 120° C. and then, as heat-fixing, 130% elongated along the machine direction at 120° C. and 90% relaxed along the machine direction to obtain a 18 μm-thick microporous membrane.

The compositions of the microporous membranes of Examples 1 to 5 and Comparative Examples 1 to 2 are shown in Table 1.

TABLE 1

| | | | | | | Comparative | Comparative |
|---|---|---|---|---|---|---|---|
| | | | | | | Example | Example |
| | Example 1 | Example 2 | Example 3 | Example 4 | Example 6 | 1 | 2 |
| Composition | Preparation | Preparation | Preparation | Preparation | Preparation | Comparative | Comparative |
| | Example | Example | Example | Example | Example | Preparation | Preparation |
| | 1 | 2 | 3 | 4 | 5 | Example 1 | Example 2 |
| HDPE1:HDPE2 | 1:1 | 1:1 | 1:1 | 1.1 | 1:1 | 1:1 | 1:1 |
| weight ratio | | | | | | | |
| Pore-forming | ◯ | ◯ | ◯ | ◯ | ◯ | X | ◯ |
| particles are | | | | | | | |
| surface-treated | | | | | | | |
| or not | | | | | | | |
| Average particle | 60 nm | 60 nm | 60 nm | 60 nm | 60 nm | 60 nm | 1.5 μm |
| diameter (D50) of | | | | | | | |
| pore-forming | | | | | | | |
| particles | | | | | | | |
| Kinds of pore- | carbonate | carbonate | carbonate | carbonate | carbonate | calcium | calcium |
| forming particles | calcium | calcium | calcium | calcium | calcium + | carbonate | carbonate |
| | | | | | barium | | |
| | | | | | sulfate | | |

### Experimental Example 1: Measurement of Porosity of Microporous Membrane

Each microporous membrane prepared in Examples and Comparative Examples was cut into a size of a width 50 mm×a length 50 mm to prepare three specimens per each Example or Comparative Example, and then, volumes, masses and density thereof were measured and averaged, and the average values are put in Equation 1 to obtain porosity (%).

Porosity (%)={volume(cm³)−mass(g)/density(g/cm³)}/volume(cm³)×100 [Equation 1]

### Experimental Example 2: Measurement of Permeability of Microporous Membrane

Each microporous membrane prepared in Examples and Comparative Examples was cut into a size of a width 50 mm×a length 50 mm from its left, middle, and right regions to prepare three specimens per each Example or Comparative Example, and a time to take for air of 100 cc to pass each specimen was measured by using a permeability measuring device EG01-55-1MR (Asahi Seiko Inc., Japan). The times were measured three times, and average values were calculated to measure permeability.

### Experimental Example 3: Measurement of Puncture Strength of Microporous Membrane

Each microporous membrane prepared in Examples and Comparative Examples was cut into a width 50 mm×a length 50 mm at 10 different regions to obtain 10 specimens, and then the specimen was placed on a 10 cm hole by using GATO Tech G5 equipment, and a puncturing force was measured, while the specimen was pressed down with a 1 mm probe. The puncture strength of each specimen was 3 times measured for each, and the average was calculated.

### Experimental Example 4: Measurement of Tensile Strength in Length Direction (MD) of Microporous Membrane

Each microporous membrane prepared in Examples and Comparative Examples was cut into a rectangular shape of a width 10 mm×a length 50 mm at 10 different regions to obtain 10 specimens, and then each specimen was mounted on UTM (a tensile strength tester), clipped to have a measuring length of 20 mm, and pulled to measure average tensile strength in the machine direction (MD).

The measurement results of Experimental Examples 1 to 4 are shown in Table 2.

TABLE 2

| | Ex- | Ex- | Ex- | Ex- | Ex- | Com- | Com- |
|---|---|---|---|---|---|---|---|
| | am- | am- | am- | am- | am- | parative | parative |
| | ple | ple | ple | ple | ple | Exam- | Exam- |
| | 1 | 2 | 3 | 4 | 5 | ple 1 | ple 2 |
| Porosity (%) | 45 | 43 | 48 | 53 | 48 | 38 | 32 |
| Permeability | 150 | 170 | 135 | 140 | 175 | 350 | 500 |
| (sec/100 cc) | | | | | | | |
| Puncture | 250 | 280 | 290 | 280 | 280 | 180 | 200 |
| strength (gf) | | | | | | | |
| MD tensile | 1350 | 1430 | 1290 | 1630 | 1450 | 1050 | 1000 |
| strength | | | | | | | |
| (kgf/cm²) | | | | | | | |

As shown in Table 2, the microporous membranes according to Examples 1 to 5 showed high porosity, low permeability, high puncture strength, and high tensile strength and thus overall excellent properties.

On the contrary, the microporous membrane using the nonsurface-treated pore-forming particle according to Comparative Example 1 had no uniform pores and thus deteriorated permeability and also, low puncture strength and low tensile strength in a machine direction. The microporous membrane using a pore-forming particle having an average particle diameter of greater than 300 nm according to Comparative Example 2 had no fine pore structure and thus showed deteriorated permeability.

While specific parts of the present invention was detailed described in above, the person having ordinary skills in the art may clearly understand that the specific descriptions are only exemplary embodiments, and the scope of the present invention is not limited thereto. Accordingly, the substantial scope of the present invention shall be determined only according to the attached claims and the equivalents thereof.

1. A microporous membrane, comprising a microporous membrane comprising a thermoplastic resin having a melting point of 100° C. to 200° C. and pore-forming particle,
wherein the pore-forming particles have an average particle size of 300 nm or less, and are surface-treated with at least one selected from the group consisting of a phosphonic acid containing alkyl group having 10 or more carbon atoms, a carboxylic acid containing an alicyclic hydrocarbon group having 6 to 20 carbon atoms, resin acid, a benzene sulfonic acid containing alkyl group having 10 or more carbon atoms and a salt thereof.

2. The microporous membrane of claim 1, wherein the pore-forming particles are inorganic particles selected from the group consisting of alumina, silica, titania, zirconia, magnesia, ceria, zinc oxide, iron oxide, silicon nitride, titanium nitride, boron nitride, calcium carbonate, barium sulfate, barium titanate, aluminum sulfate, aluminum hydroxide, calcium titanate, talc, calcium silicate, and magnesium silicate.

3. The microporous membrane of claim 1, wherein the pore-forming particles are included in an amount of 20 wt % to 50 wt % based on a total weight of the microporous membrane.

4. The microporous membrane of claim 1, which has permeability of less than or equal to 300 sec/100 cc.

5. The microporous membrane of claim 1, which has porosity of greater than or equal to 40%.

6. The microporous membrane of claim 1, which has puncture strength of greater than or equal to 200 gf.

7. The microporous membrane of claim 1, which has a machine direction (MD) tensile strength of greater than or equal to 1000 Kgf/cm².

8. The microporous membrane of claim 1, which has a thickness ranging from 1 μm to 20 μm.

9. A microporous membrane comprising surface-treated pore-forming particles having an average particle diameter of 300 nm or less,
wherein the pore-forming particles are included in an amount of 20 wt % to 50 wt % based on a total weight of the microporous membrane and the microporous membrane has a puncture strength of greater than or equal to 200 gf.

10. The microporous membrane of claim 9, wherein the pore-forming particles are surface-treated by at least one selected from phosphonic acid containing an alkyl group having 10 to 20 carbons, carboxylic acid containing an alicyclic hydrocarbon group having 6 to 20 carbon atoms, resin acid, benzene sulfonic acid containing an alkyl group having 10 to 20 carbons, and a salt thereof.

11. The microporous membrane of claim 9, wherein the pore-forming particles are inorganic particles including at least one selected from alumina, silica, titania, zirconia, magnesia, ceria, zinc oxide, iron oxide, silicon nitride, titanium nitride, boron nitride, calcium carbonate, barium sulfate, barium titanate, aluminum sulfate, aluminum hydroxide, calcium titanate, talc, calcium silicate, and magnesium silicate.

12. The microporous membrane of claim 9, which has machine direction (MD) tensile strength of greater than or equal to 1000 Kgf/cm².

13. The microporous membrane of claim 9, which has porosity of greater than or equal to 40%.

14. A method of producing the microporous membrane, which comprises
preparing a composition for a microporous membrane by mixing pore-forming particles surface-treated with a surfactant and a thermoplastic resin having a melting point of 100° C. to 200° C.;
extrusion-molding the composition for a microporous membrane to form a precursor film;
annealing the precursor film at a temperature of (Tm-80) ° C. to (Tm-3) ° C.; and
first elongating the annealed precursor film by 40% to 400% at a temperature of 0° C. to 50° C. in a machine direction (MD) or a transverse direction (TD) respectively or simultaneously, wherein the Tm is a melting point of the thermoplastic resin.

15. The method of claim 14, wherein the pore-forming particles surface-treated with the surfactant have an average particle diameter of less than or equal to 300 nm, and the surfactant is at least one selected from phosphonic acid containing an alkyl group having 10 or more carbon atoms, a carboxylic acid containing an alicyclic hydrocarbon group having 6 to 20 carbon atoms, resin acid, benzene sulfonic acid containing an alkyl group having 10 or more carbon atoms, and a salt thereof.

16. The method of claim 14, wherein the pore-forming particles are used in an amount of 20 wt % to 50 wt % based on a total weight of the composition for microporous membrane.

17. An electrochemical cell comprising a positive electrode, a negative electrode, a microporous membrane, and an electrolyte, wherein the microporous membrane is the microporous membrane according to claim 1.

18. The electrochemical cell of claim 17, which is a lithium rechargeable cell.

19. An electrochemical cell comprising a positive electrode, a negative electrode, a microporous membrane, and an electrolyte, wherein the microporous membrane is the microporous membrane produced according to claim 14.

20. The electrochemical cell of claim 19, which is a lithium rechargeable cell.
